(19) United States
(12) Patent Application Publication
(10) Pub. No.: US 2026/0057371 A1
(43) Pub. Date: Feb. 26, 2026

(54) METHOD AND SYSTEM FOR PREDICTING A REAL-TIME EMBEDDING

(71) Applicant: MASTERCARD INTERNATIONAL INCORPORATED, PURCHASE, NY (US)

(72) Inventors: Sarthak MALIK, Muzaffarnagar (IN); Aakarsh MALHOTRA, New Delhi (IN); Anil Kumar SURISETTY, Visakhapatnam (IN); Himank SEHGAL, Chandigarh (IN); Priyanka CHUDASAMA, New Delhi (IN)

(21) Appl. No.: 18/810,478

(22) Filed: Aug. 20, 2024

(51) Int. Cl. G06Q 20/34

(52) U.S. Cl. CPC G06Q 20/357

(57) ABSTRACT

Methods and systems for predicting a real-time embedding for a real-time transaction between a cardholder and a merchant are disclosed. The method performed by a server system includes receiving an embedding generation request for the real-time transaction. The method further includes accessing a static embedding, a set of velocity features, and a set of real-time velocity features from a database associated with the server system. The method further includes computing a difference between the set of real-time velocity features and the set of velocity features. The method further includes generating, by a prediction model associated with the server system, a real-time embedding prediction for the real-time transaction based, at least in part, on the static embedding, the set of velocity features, and the computed difference.

### TECHNICAL FIELD

The present disclosure relates to artificial intelligence-based processing systems and, more particularly, to electronic methods and complex processing systems for predicting a real-time embedding for a real-time event such as a transaction between a cardholder and a merchant.

### BACKGROUND

In recent years, there has been a widespread adoption of Artificial Intelligence (AI) and/or Machine Learning (ML) models across various industries and organizations to perform various tasks. These tasks include a wide range of applications such as fraud detection, recommendation systems, anomaly detection, Natural Language Processing (NLP), classification systems, and more. Typically, AI/ML models are trained using training data sourced from various sources. For example, a fraud detection model can be trained using historical transaction data to determine whether a payment transaction will be a fraudulent or a non-fraudulent transaction. Once the training stage is complete, the model enters the deployment stage where it analyzes new data to make predictions.

During the deployment stage, new data undergoes several preprocessing steps such as data preparation, feature extraction, dimensionality reduction, and embedding generation. Embeddings play a crucial role in representing data points, particularly text or categorical features, in a lower-dimensional space where meaningful relationships and patterns are discernible. This property of embeddings helps the model understand the hidden patterns or behaviors in the new data to generate the predictions. In some instances, embeddings may be generated by a separate model and then utilized by another model to perform different tasks. For example, for a new payment transaction, the fraud detection model extracts features from the transaction and generates an embedding using the said features. Then, the fraud detection model can utilize the said embedding to determine whether the new payment transaction is a fraudulent or a non-fraudulent transaction.

While AI/ML models have demonstrated promising results in various domains, they encounter challenges when tasked with analyzing large datasets in real-time applications such as fraud detection, where quick results or low latency are required. As may be understood, for applications where a large corpus of data has to be analyzed for generating these embeddings, a significant latency or delay is introduced in the predictive process. For example, a payment processor has to perform fraud detection of millions of transactions every hour, therefore generating embeddings by analyzing historical transaction data for each cardholder will be quite time-consuming. On the other hand, to avoid unnecessary hiccups in the transaction process such as failure due to timeout, the latency of such a fraud detection task has to be reduced.

Conventionally, to mitigate this problem, static embeddings are computed for predefined time intervals (e.g., weekly intervals, bi-weekly intervals, and so on). During each interval, a static embedding is generated and utilized by the model for predictions related to events occurring within that timeframe. For example, a static embedding can be generated for each cardholder and merchant, then the same can be utilized for fraud detection for all transactions performed by said cardholder and merchant over the week. However, despite their utility, static embeddings are not reliable since they are not generated in the real-time for the specific event for which the prediction has to be performed. It is understood that, due to the dynamic nature of an application, there may exist a significant difference between static embedding and real-time embedding, which would lead to poor predictions by the model. Further, as time passes, the performance of the model using the static embedding would degrade as well.

Thus, there exists a need for technical solutions, such as improved methods and systems for predicting a real-time embedding for a real-time event such as a transaction between a cardholder and a merchant while overcoming the aforementioned technical drawbacks.

### SUMMARY

Various embodiments of the present disclosure provide methods and systems for predicting a real-time embedding for a real-time transaction between a cardholder and a merchant for a real-time event.

In an embodiment, a computer-implemented method for predicting a real-time embedding for a real-time transaction between a cardholder and a merchant is disclosed. The computer-implemented method performed by a server system includes receiving an embedding generation request for the real-time transaction. Further, the computer-implemented method includes accessing a static embedding, a set of velocity features, and a set of real-time velocity features from a database associated with the server system. Further, the computer-implemented method includes computing a difference between the set of real-time velocity features and the set of velocity features. Further, the computer-implemented method includes generating, by a prediction model associated with the server system, a real-time embedding prediction for the real-time transaction based, at least in part, on the static embedding, the set of velocity features, and the computed difference.

In another embodiment, a server system is disclosed. The server system includes a communication interface and a memory including executable instructions. The server system also includes a processor communicably coupled to the memory. The processor is configured to execute the instructions to cause the server system, at least in part, to receive an embedding generation request for the real-time transaction. The server system is further caused to access a static embedding, a set of velocity features, and a set of real-time velocity features from a database associated with the server system. The server system is further caused to compute a difference between the set of real-time velocity features and the set of velocity features. The server system is further caused to generate, by a prediction model associated with the server system, a real-time embedding prediction for the real-time transaction based, at least in part, on the static embedding, the set of velocity features, and the computed difference.

In yet another embodiment, a non-transitory computer-readable storage medium is disclosed. The non-transitory computer-readable storage medium includes computer-executable instructions that, when executed by at least a processor of a server system, cause the server system to perform a method. The method includes receiving an embedding generation request for the real-time transaction. Further, the method includes accessing a static embedding, a set of velocity features, and a set of real-time velocity features from a database associated with the server system. Further, the method includes computing a difference between the set of real-time velocity features and the set of velocity features. Further, the method includes generating, by a prediction model associated with the server system, a real-time embedding prediction for the real-time transaction based, at least in part, on the static embedding, the set of velocity features, and the computed difference.

In yet another embodiment, a computer-implemented method for predicting a real-time embedding for a real-time event is disclosed. The computer-implemented method performed by a server system includes receiving an embedding generation request for the real-time event. Further, the computer-implemented method includes accessing a static embedding, a set of velocity features, and a set of real-time velocity features from a database associated with the server system. Further, the computer-implemented method includes computing a difference between the set of real-time velocity features and the set of velocity features. Further, the computer-implemented method includes generating, by a prediction model associated with the server system, a real-time embedding prediction for the real-time event based, at least in part, on the static embedding, the set of velocity features, and the computed difference.

### BRIEF DESCRIPTION OF THE FIGURES

For a more complete understanding of example embodiments of the present technology, reference is now made to the following descriptions taken in connection with the accompanying drawings in which:

FIG. 1 illustrates a schematic representation of an environment related to at least some example embodiments of the present disclosure;

FIG. 2 illustrates a schematic representation of another environment related to at least some example embodiments of the present disclosure;

FIG. 3 illustrates a simplified block diagram of a server system, in accordance with an embodiment of the present disclosure;

FIG. 4 illustrates a schematic representation of a process for generating a static embedding for a transaction, in accordance with an embodiment of the present disclosure;

FIG. 5 illustrates a schematic representation of a process for generating a real-time embedding prediction for a real-time transaction, in accordance with an embodiment of the present disclosure;

FIG. 6 illustrates a table indicating various experimental results, in accordance with an embodiment of the present disclosure;

FIG. 7 illustrates a schematic representation of a process for generating predictions for various down-stream tasks, in accordance with an embodiment of the present disclosure;

FIG. 8 illustrates a process flow diagram depicting a method for predicting a real-time embedding for a real-time transaction between a cardholder and a merchant, in accordance with an embodiment of the present disclosure;

FIG. 9 illustrates a process flow diagram depicting a method for predicting a real-time embedding for a real-time event, in accordance with an embodiment of the present disclosure;

FIG. 10 illustrates a simplified block diagram of an acquirer server, in accordance with an embodiment of the present disclosure;

FIG. 11 illustrates a simplified block diagram of an issuer server, in accordance with an embodiment of the present disclosure; and

FIG. 12 illustrates a simplified block diagram of a payment server, in accordance with an embodiment of the present disclosure.

The drawings referred to in this description are not to be understood as being drawn to scale except if specifically noted, and such drawings are only exemplary in nature.

### DETAILED DESCRIPTION

In the following description, for purposes of explanation, numerous specific details are set forth in order to provide a thorough understanding of the present disclosure. It will be apparent, however, to one skilled in the art that the present disclosure can be practiced without these specific details. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

Reference in this specification to “one embodiment” or “an embodiment” means that a particular feature, structure, or characteristic described in connection with the embodiment is included in at least one embodiment of the present disclosure. The appearances of the phrase “in an embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not for other embodiments.

Moreover, although the following description contains many specifics for the purposes of illustration, anyone skilled in the art will appreciate that many variations and/or alterations to said details are within the scope of the present disclosure. Similarly, although many of the features of the present disclosure are described in terms of each other, or in conjunction with each other, one skilled in the art will appreciate that many of these features can be provided independently of other features. Accordingly, this description of the present disclosure is set forth without any loss of generality to, and without imposing limitations upon, the present disclosure.

Embodiments of the present disclosure may be embodied as an apparatus, a system, a method, or a computer program product. Accordingly, embodiments of the present disclosure may take the form of an entire hardware embodiment, an entire software embodiment (including firmware, resident software, micro-code, etc.), or an embodiment combining software and hardware aspects that may all generally be referred to herein as a “circuit”, “engine”, “module”, or “system”. Furthermore, aspects of the present disclosure may take the form of a computer program product embodied in one or more computer-readable storage media having computer-readable program code embodied thereon.

For elucidatory purposes, the terms “account holder”, “user”, “cardholder”, “consumer”, “card” and “buyer” are used interchangeably throughout the description and refer to a person who has a payment account or a payment card (e.g., credit card, debit card, etc.) associated with the payment account, that will be used by a merchant to perform a payment transaction. The payment account may be opened via an issuing bank or an issuer server.

The term “merchant”, used throughout the description generally refers to a seller, a retailer, a purchase location, an organization, or any other entity that is in the business of selling goods or providing services, and it can refer to either a single business location or a chain of business locations of the same entity. For example, the merchants may include buyers and sellers of commodities for profit, traders, a storekeeper, health care centers, hotels, restaurants, vehicle rentals, petrol/gas stations, etc.

The terms “payment network” and “card network” are used interchangeably throughout the description and refer to a network or collection of systems used for the transfer of funds through the use of cash substitutes. Payment networks may use a variety of different protocols and procedures to process the transfer of money for various types of transactions. Payment networks are companies that connect an issuing bank with an acquiring bank to facilitate online payment. Transactions that may be performed via a payment network may include product or service purchases, credit purchases, debit transactions, fund transfers, account withdrawals, etc. Payment networks may be configured to perform transactions via cash substitutes that may include payment cards, letters of credit checks, financial accounts, etc. Examples of networks or systems configured to perform as payment networks include those operated by such as Mastercard®.

The term “payment card”, used throughout the description, refers to a physical or virtual card linked with a financial or payment account that may be presented to a merchant or any such facility to fund a financial transaction via the associated payment account. Examples of the payment card include, but are not limited to, debit cards, credit cards, prepaid cards, virtual payment numbers, virtual card numbers, forex cards, charge cards, e-wallet cards, and stored-value cards. A payment card may be a physical card that may be presented to the merchant for funding the payment. Alternatively, or additionally, the payment card may be embodied in the form of data stored in a user device, where the data is associated with a payment account such that the data can be used to process the financial transaction between the payment account and a merchant's financial account. In some instances, while swiping the payment card at the merchant's end, the merchant can raise a preauthorization request to check the eligibility of the merchant to use the service that the cardholder is willing to receive from the merchant. In this case, the payment will not be made at the beginning of receiving the service, instead, it will be made upon completion of the service or at the time of checking out. Herein, the payment may or may not be the same as the amount requested in the preauthorization request.

The term “payment account” used throughout the description refers to a financial account that is used to fund a financial transaction. Examples of the financial account include, but are not limited to, a savings account, a credit account, a checking account, and a virtual payment account. The financial account may be associated with an entity such as an individual person, a family, a commercial entity, a company, a corporation, a governmental entity, a non-profit organization, and the like. In some scenarios, the financial account may be a virtual or temporary payment account that can be mapped or linked to a primary financial account, such as those accounts managed by payment wallet service providers, and the like.

The terms “payment transaction”, “financial transaction”, “event”, and “transaction” are used interchangeably throughout the description and refer to a transaction of payment of a certain amount being initiated by the cardholder. More specifically, refers to electronic financial transactions including, for example, online payment, payment at a terminal (e.g., point of sale (POS) terminal, ATM, self-service kiosks, and the like). In the case of preauthorization, such a transaction may not happen before receiving the service, but instead at the time of the completion of receiving the service.

### OVERVIEW

Various embodiments of the present disclosure provide methods, systems electronic devices, and computer program products for predicting a real-time embedding for a real-time event such as a transaction between a cardholder and a merchant.

In an embodiment, the server system may be a payment server associated with a payment network that is configured to receive an embedding generation request for the real-time transaction. Herein, the real-time transaction is performed between a cardholder and a merchant.

In another embodiment, the server system is configured to access a static embedding, a set of velocity features, and a set of real-time velocity features from a database associated with the server system.

To access the set of real-time velocity features, the server system is configured to extract one or more real-time transaction features from the embedding generation request for the real-time transaction. Then, the server system is configured to generate the set of real-time velocity features based, at least in part, on the one or more real-time transaction features. Further, the server system is configured to store the set of real-time velocity features in the database.

To access the set of velocity features and the static embedding, the server system is configured to access a historical transaction dataset from the database. Herein, the historical transaction dataset includes a plurality of transaction attributes associated with each of a plurality of transactions performed between a plurality of cardholders and a plurality of merchants. Then, the server system is configured to generate a set of cardholder features for each cardholder and a set of merchant features for each merchant based, at least, in part, on the plurality of transaction attributes. Then, the server system is configured to generate a bipartite graph based, at least in part, on the set of cardholder features for each cardholder and the set of merchant features for each merchant. The bipartite graph includes a set of cardholder nodes associated with the plurality of cardholders and a set of merchant nodes associated with the plurality of merchants. Herein, the set of cardholder nodes and the set of merchant nodes are connected with a plurality of edges. Each edge indicates a transaction performed between a particular cardholder node and a particular merchant node.

Then, the server system is configured to generate a set of cardholder velocity features for the cardholder and a set of merchant velocity features for the merchant based, at least in part, on the bipartite graph.

Then, the server system is configured to generate the set of velocity features based, at least in part, on the set of cardholder velocity features and the set of merchant velocity features. Further, the set of velocity features may be stored in the database.

Further, the server system is configured to generate, by a static embedding model associated with the server system, a static embedding based, at least in part, on the set of velocity features. Furthermore, the server system is configured to store the static embedding in the database. In some instances, the static embedding is updated after a predefined time duration.

In another embodiment, the server system is configured to compute a difference between the set of real-time velocity features and the set of velocity features. Additionally, the server system is configured to generate, by a prediction model associated with the server system, a real-time embedding prediction for the real-time transaction based, at least in part, on the static embedding, the set of velocity features, and the computed difference.

In another embodiment, the server system is configured to compute a performance value of a static embedding model based, at least in part, on one or more performance metrics. Then, re-train the static embedding model upon determining that the performance value is lower than a performance threshold value.

In another embodiment, the server system is configured to receive a prediction request associated with a down-stream task and generate, by a down-stream task model associated with the server system, a task-specific prediction for the down-stream task based, at least in part, on the real-time embedding prediction.

In another embodiment, the server system is configured to receive an embedding generation request for the real-time event. Then, the server system is configured to access a static embedding, a set of velocity features, and a set of real-time velocity features from a database associated with the server system. Then, the server system is configured to compute a difference between the set of real-time velocity features and the set of velocity features. Then, the server system is configured to generate, by a prediction model associated with the server system, a real-time embedding prediction for the real-time event based, at least in part, on the static embedding, the set of velocity features, and the computed difference.

Herein, to access the set of real-time velocity features, the server system is configured to (1) extract one or more real-time event-related features from the embedding generation request for the real-time event, (2) generate the set of real-time velocity features based, at least in part, on the one or more real-time event-related features, and (3) store the set of real-time velocity features in the database.

Herein, to access the set of velocity features and the static embedding, the server system is configured to (1) access, a historical dataset from the database. The historical dataset includes a plurality of attributes associated with a series of historical events, each historical event from the series of historical events being performed by a plurality of entities. (2) generate a set of historical event features for the series of historical events based, at least, in part, on the plurality of attributes, (3) generate an event-specific graph based, at least in part, on the set of historical event features. The event-specific graph includes a set of entity nodes corresponding to the plurality of entities, wherein the set of entity nodes are connected with a plurality of edges, each edge indicating a relationship between distinct entity nodes from the set of entity nodes, (4) generate the set of velocity features based, at least in part, on the entity-specific graph, (5) store the set of velocity features in the database, (6) generate, by a static embedding model associated with the server system, a static embedding based, at least in part, on the set of velocity features, wherein the static embedding is updated after a predefined time duration, and (7) store the static embedding in the database.

Various embodiments of the present disclosure offer multiple advantages and technical effects. For instance, the present disclosure provides a novel process for predicting a real-time embedding for a real-time event such as a real-time or ongoing payment transaction between a cardholder and a merchant. As may be understood, the present disclosure provides an approach for generating a real-time embedding prediction instead of computing the actual real-time embedding. This real-time embedding prediction can then be utilized by any down-stream task model to generate a task-specific prediction. This aspect provides a technical effect of improving the performance of the down-stream task model when compared to predictions generated using static embedding. In particular, the real-time embedding prediction provides more information to the down-stream task model regarding the underlying pattern or behavior of an entity, when compared with the static embedding. Various experiments described later on using the real-time embedding prediction depict that the performance of the down-stream task model is comparable to the performance of the said down-stream task model if the actual real-time embedding was used. Furthermore, it is noted that the computational resources required for generating the real-time embedding prediction are significantly lower than those required for generating the actual real-time embedding.

Further, it may be appreciated that the process of predicting the real-time embedding for an entity using the computed difference and the static embedding is quick and reliable. Therefore, the computation time for the real-time embedding prediction is significantly lower than the computation time required for determining the actual real-time embedding. Therefore, the real-time embedding prediction can be used in applications where low latency is desired, for example, fraud detection. Furthermore, since these predictions are generated in real-time time, unlike static embeddings there is no need to update them on a periodic basis. Further, the time required to compute the real time embedding prediction using the proposed approach is lower, which plays a crucial role in performing tasks such as predictions related to real-time transactions where any delay in intelligence score provided for these transactions have to be avoided.

Additionally, the present disclosure describes updating the static embedding after a predefined time, since this static embedding is used in part to generate the real-time embedding prediction, after each update, the performance of the real-time embedding prediction will also improve. Furthermore, since the static embedding model responsible for generating the static embedding is re-trained after it encounters a performance drop below the performance threshold value, the accuracy of the real-time embedding prediction remains stable.

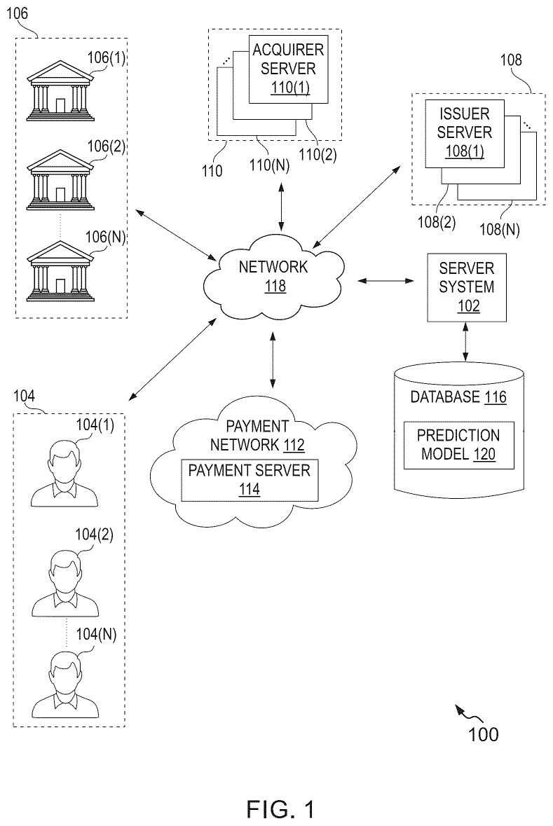

Various example embodiments of the present disclosure are described hereinafter with reference to FIG. 1 to FIG. 12.

FIG. 1 illustrates a block diagram representation of an environment 100 related to at least some example embodiments of the present disclosure. Although the environment 100 is presented in one arrangement, other embodiments may include the parts of the environment 100 (or other parts) arranged otherwise depending on, for example, predicting a real-time embedding for a real-time transaction between a cardholder such as a cardholder 104(1) and a merchant such as 106(1), and so on.

The environment 100 generally includes a plurality of entities such as a server system 102, a plurality of cardholders 104(1), 104(2), 104(3),. 104(N), where ‘N’ is a non-zero natural number (collectively referred to as a ‘plurality of cardholders 104’ or ‘cardholders 104’ or singularly as ‘cardholder 104(1)’), a plurality of merchants 106(1), 106(2), . . . 106(N) where ‘N’ is a non-zero natural number (collectively referred to as a ‘plurality of merchants 106’ or ‘merchants 106’ or singularly as ‘merchant 106(1)’), a plurality of issuer servers 108(1), 108(2), . . . 108(N), where ‘N’ is a non-zero natural number (collectively referred to as a ‘plurality of issuer servers 108’ or ‘issuer servers 108’ or singularly as ‘issuer server 108(1)’), a plurality of acquirer servers 110(1), 110(2), . . . 110(N), where ‘N’ is a non-zero natural number (collectively referred to as a ‘plurality of acquirer servers 110’ or ‘acquirer servers 110’ or singularly as ‘acquirer server 110(1)’), a payment network 112 including a payment server 114, and a database 116 each coupled to, and in communication with (and/or with access to) a network 118.

In various examples, the network 118 may include, without limitation, a light fidelity (Li-Fi) network, a local area network (LAN), a wide area network (WAN), a metropolitan area network (MAN), a satellite network, the Internet, a fiber optic network, a coaxial cable network, an infrared (IR) network, a radio frequency (RF) network, a virtual network, and/or another suitable public and/or private network capable of supporting communication among two or more of the parts or users illustrated in FIG. 1, or any combination thereof.

Various entities in the environment 100 may connect to the network 118 in accordance with various wired and wireless communication protocols, such as Transmission Control Protocol and Internet Protocol (TCP/IP), User Datagram Protocol (UDP), 2nd Generation (2G), 3rd Generation (3G), 4th Generation (4G), 5th Generation (5G) communication protocols, Long Term Evolution (LTE) communication protocols, New Radio (NR) communication protocol, any future communication protocol, or any combination thereof. In some instances, the network 118 may utilize a secure protocol (e.g., Hypertext Transfer Protocol (HTTP), Secure Socket Lock (SSL), and/or any other protocol, or set of protocols for communicating with the various entities depicted in FIG. 1.

In an embodiment, the cardholders 104 use one or more payment cards (not shown) to make payment transactions. As may be understood, the cardholder (e.g., the cardholder 104(1)) may be any individual, representative of a corporate entity, a non-profit organization, or any other person who is presenting payment account details during an electronic payment transaction. The cardholder (e.g., the cardholder 104(1)) may have a payment account issued by an issuing bank (not shown in figures) associated with the issuer server such as issuer server 108(1) and may be provided with a payment card with financial or other account information encoded onto the payment card such that the cardholder (i.e., the cardholder 104(1)) may use the payment card to initiate and complete a payment transaction using a bank account at the issuing bank.

In another embodiment, the cardholders 104 may use their corresponding electronic devices (not shown) to access a mobile application or a website associated with the issuing bank, or any third-party payment application to perform a payment transaction. In various non-limiting examples, the electronic devices may refer to any electronic devices such as, but not limited to, personal computers (PCs), tablet devices, smart wearable devices, Personal Digital Assistants (PDAs), voice-activated assistants, Virtual Reality (VR) devices, smartphones, laptops, and the like.

In an embodiment, the merchants 106 may include retail shops, restaurants, supermarkets or establishments, government and/or private agencies, or any such places equipped with POS terminals, where cardholders 104 visit to perform financial transactions in exchange for any goods and/or services or any financial transactions.

In one scenario, the cardholders 104 may use their corresponding payment accounts (or payment cards) to conduct payment transactions with the merchants 106. Moreover, it may be noted that each of the cardholders 104 may use their corresponding payment cards differently or make the payment transaction using different means of payment.

For instance, the cardholder 104(1) may enter payment account details on an electronic device (not shown) associated with the cardholder 104(1) to perform an online payment transaction via a payment gateway associated with the merchant's website. In another example, the cardholder 104(2) may utilize the payment card to perform an offline payment transaction using a Point Of Sale (POS) device at the merchant's store. In yet another example, the cardholder 104(3) may enter details of the payment card to transfer funds in the form of fiat currency on an e-commerce platform to buy goods. In other words, each cardholder of the plurality of cardholders 104 (e.g., the cardholder 104(1)) may transact at any merchant from the plurality of merchants 106 (e.g., the merchant 106(1)).

In one embodiment, the cardholders 104 are associated with the issuer servers 108. In one embodiment, the issuer servers 108 are associated with financial institutions normally called an “issuer bank”, “issuing bank” or simply “issuer”, in which a cardholder (e.g., the cardholder 104(1)) may have the payment account, (which also issues a payment card, such as a credit card or a debit card), and provides microfinance banking services (e.g., payment transaction using credit/debit cards) for processing electronic payment transactions, to the cardholder (e.g., the cardholder 104(1)).

In an embodiment, the merchants 106 are generally associated with the acquirer servers 110. In one embodiment, the acquirer servers 110 are associated with financial institutions (e.g., a bank) that process financial transactions for the merchants 106. This can be an institution that facilitates the processing of payment transactions for physical stores, merchants, or institutions that own platforms that make either online purchases or purchases made via software applications possible. The terms “acquirer”, “acquiring bank”, “acquiring bank” or “acquirer server” will be used interchangeably herein. Due to the complexity of the banking network, a cardholder 104(1) and a merchant 106(1) may be associated with the same banking institution, e.g., ABC Bank. In such a situation, ABC Bank will act as an issuer for the cardholder 104(1) and an acquirer for the merchant 106(1). Thus, a banking institution may act as both an acquirer and/or an issuer depending on the needs of its clients.

In one embodiment, the payment network 112 may be used by the payment card issuing authorities as a payment interchange network. Examples of the payment cards include debit cards, credit cards, etc. A payment interchange network allows for the exchange of electronic payment transaction data between issuers and acquirers. The payment network 112 includes the payment server 114 which is responsible for facilitating the various operations of the payment network 112. In one scenario, the payment server 114 is configured to operate a payment gateway for facilitating the various entities in the payment network 112 to perform digital transactions.

As described earlier, due to the time-consuming and complex process of generating embeddings for an event such as a payment transaction between the cardholder 104(1) and merchant 106(1), their use in time-sensitive applications requiring low latency is not possible. Further, the conventional approach of using static embeddings instead of actual real-time embeddings is unable to deliver satisfactory results or performance.

The above-mentioned technical problems, among other problems, are addressed by one or more embodiments implemented by the server system 102 and methods thereof provided in the present disclosure.

In one embodiment, the server system 102 is configured to predict a real-time embedding for a real-time event such as a payment transaction.

In some embodiments, the server system 102 may be deployed as a standalone server or may be implemented in the cloud as software as a service (Saas). In one embodiment, the environment 100 may further include the database 116 coupled with the server system 102. In an example, the server system 102 coupled with the database 116 is embodied within the payment server 114, however, in other examples, the server system 102 can be a standalone component (acting as a hub) connected to the acquirers 110 and the issuers 108. The database 116 may be incorporated in the server system 102 or maybe an individual entity connected to the server system 102 or maybe a database stored in cloud storage. In one embodiment, the database 116 may store a prediction model 120, and other necessary machine instructions required for implementing the various functionalities of the server system 102 such as firmware data, operating system, and the like.

In various non-limiting examples, the database 116 may include one or more Hard Disk Drives (HDD), Solid-State Drives (SSD), an Advanced Technology Attachment (ATA) adapter, a Serial ATA (SATA) adapter, a Small Computer System Interface (SCSI) adapter, a redundant array of independent disks (RAID) controller, a Storage Area Network (SAN) adapter, a network adapter, and/or any component providing the server system 102 with access to the database. In one implementation, the database 116 may be viewed, accessed, amended, updated, and/or deleted by an administrator (not shown) associated with the server system 102 through a database management system (DBMS) or relational database management system (RDBMS) present within the database 116.

In other various examples, the database may also include multifarious data, for example, social media data, Know Your Customer (KYC) data, payment data, trade data, employee data, Anti Money Laundering (AML) data, market abuse data, Foreign Account Tax Compliance Act (FATCA) data, and fraudulent payment transaction data. In addition, the database 116 provides a storage location for data and/or metadata obtained from various operations performed by the server system 102.

In an embodiment, the prediction model 120 may refer an AI or ML model that is configured to predict a real-time embedding for an event such as a payment transaction. In various non-limiting examples, the prediction model 120 may include an autoencoder (AE) model, variational autoencoder (VAE) model, generative adversarial networks (GANs), and the like. For the sake of simplicity, the prediction model 120 is assumed to be an autoencoder model however, other models may also be used to implement the prediction model 120. The autoencoder model is a neural network model that consists of input layers, hidden layers and an output layer. The autoencoder is trained to generate an embedding or encoding of the input data and using it decode or reconstruct the input data. This is a self-supervised process in which the input data serves as both the input and target output during the training.

In an embodiment, the server system 102 is configured to receive an embedding generation request for the real-time transaction performed between the cardholder 104(1) and merchant 106(1). For instance, a transaction takes place between the cardholder 104(1) and merchant 106(1), and the payment processor or the issuer wishes to determine the likelihood of the ongoing transaction being fraud or non-fraud. To achieve this, the issuer server 108(1) or payment server 114 may request the server system 102 to perform fraud detection through a fraud detection model (i.e., an example of a down-stream task model described later on). For performing the fraud detection process, the server system 102 may use an estimated or predicted real-time embedding for the real-time transaction. In particular, the server system 102 is configured to access a static embedding, a set of velocity features, and a set of real-time velocity features from a database associated with the server system. Herein, the terms ‘static embedding’, ‘fixed embeddings’, or ‘pre-trained embeddings’, can be defined as representations of velocity features associated with entities such as cardholders, merchants, or so on in the vector space. Unlike real-time embeddings or dynamic embeddings, which are learned from scratch during the training of a specific down-stream task (such as fraud detection), static embeddings are pre-computed and remain fixed throughout the duration of the task for a predefined time duration (such as a week).

The set of velocity features refers to velocity features computed using historical data such as historical transaction data and used to generate the static embedding. The term ‘velocity features’ refers to features or metrics that capture the rate of change or movement of a variable over time. These features are valuable for understanding temporal patterns and dynamics in the input data. In an instance, in the present context, the velocity features can be generated using transaction features. The transaction features can be computed using a historical transaction dataset associated with a plurality of transactions performed between the cardholders 104 and the merchants. More specifically, the historical transaction dataset may include transaction-related information related to a plurality of payment transactions performed between a plurality of cardholders 104 with a plurality of merchants 106 within the payment network 112.

The historical transaction dataset may include but is not limited to, transaction-related information, such as transaction amount, source of funds such as bank or credit cards, transaction channel used for loading funds such as POS terminal or ATM, transaction location information, external data sources, merchant country, merchant Identifier (ID), cardholder ID, cardholder product, cardholder Permanent Account Number (PAN), Merchant Category Code (MCC), merchant location data or merchant co-ordinates, merchant name, city, zip code merchant industry, merchant super industry, ticket price or ticket Size, number of unique cards, location, transaction channel (POS/Ecomm/Cash), product code, transaction mode, and other transaction-related data. The historical transaction dataset may be used by the server system 102 to generate transaction features using one or more featurization techniques. It is noted that featurization techniques are well known in the art, therefore they are not described herein for the sake of brevity. Then, velocity features may be generated using these transaction features. In various non-limiting examples, the set of velocity features may include count and transaction amount sent in the past ‘x’ number of days to a particular user or cardholder, domestic or cross-border transaction, Point of Sale (POS) terminal capability, Card Present (CP) or Card Not Present (CNP), Gross Dollar Value (GDV) amount (may be computed based on spend ranking), E-commerce (ECOM) security level, POS machine request type such as normal request, SecureCode Phone order, Automatic Teller Machine (ATM) installment inquiry, Pre-Authorization (Pre-Auth) request, and the like.

Furthermore, the set of real-time velocity features refers to velocity features computed using data or transaction attributes associated with the real-time transaction for which the embedding generation request is received. The real-time velocity features are identical to the velocity features described earlier however, the values associated with these features are different because they are generated for different transactions. The process for generating the velocity features, static embedding, and the real-time velocity features has been described later in the present disclosure.

Then, the server system is configured to compute a difference between the set of real-time velocity features and the set of velocity features. As may be understood, the difference between the real-time velocity features and the velocity features used for generating the static embedding represents the overall change in each individual velocity feature from the set of velocity features at the instance when the real-time transaction takes place.

Further, the server system is configured to generate a real-time embedding prediction for the real-time transaction based, at least in part, on the static embedding, the set of velocity features, and the computed difference. The term ‘real-time embedding prediction’ refers to an estimate or prediction of an actual real-time embedding. In particular, the server system 102 may utilize the prediction model 120 to generate the real-time embedding prediction. More specifically, the prediction model 120 takes the static embedding, the set of velocity features, and the computed difference as an input and generates the real-time embedding prediction as an output. Thereafter, the server system 102 may utilize the real-time embedding prediction as an input to the fraud detection model to predict the likelihood of the real-time transaction being a fraud or a non-fraud transaction.

As may be appreciated, utilizing the real-time embedding prediction by a down-stream task model (e.g., fraud detection model) instead of the actual real-time embedding significantly reduces the computational resources or time required for performing predictions by the down-stream task model. Additionally, since the real-time embedding prediction is a close estimate of the actual real-time embedding, the performance of the down-stream task model is significantly improved as well when compared with results generated using the static embedding.

The number and arrangement of systems, devices, and/or networks shown in FIG. 1 are provided as an example. There may be additional systems, devices, and/or networks; fewer systems, devices, and/or networks; different systems, devices, and/or networks; and/or differently arranged systems, devices, and/or networks than those shown in FIG. 1. Furthermore, two or more systems or devices shown in FIG. 1 may be implemented within a single system or device, or a single system or device is shown in FIG. 1 may be implemented as multiple, distributed systems or devices. In addition, the server system 102 should be understood to be embodied in at least one computing device in communication with the network 118, which may be specifically configured, via executable instructions, to perform steps as described herein, and/or embodied in at least one non-transitory computer-readable media.

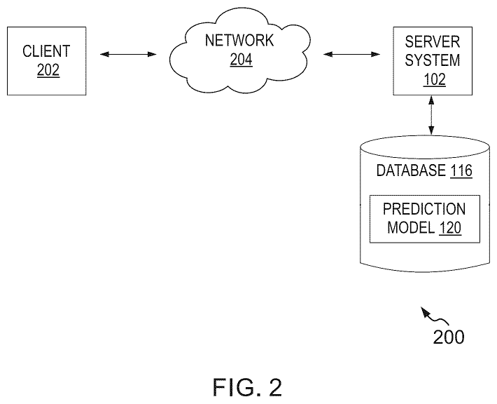

FIG. 2 illustrates a block diagram representation of another environment 200 related to at least some example embodiments of the present disclosure. Although the environment 200 is presented in one arrangement, other embodiments may include the parts of the environment 200 (or other parts) arranged otherwise depending on, for example, predicting a real-time embedding for a real-time event and so on. It is noted that FIG. 1 depicts an environment 100 for a specific implementation, i.e., in the financial domain, of the various embodiments of the present disclosure. On the other hand, FIG. 2 describes a general environment for implementing the various embodiments of the present disclosure. Since, various aspects of FIG. 2 have already been described with reference to FIG. 1, the explanation for the same are not repeated again for the sake of brevity.

The environment 200 generally includes a plurality of entities such as the server system 102, a client 202, and a database 116 each coupled to, and in communication with (and/or with access to) a network 204.

In various examples, the network 204 may include, without limitation, a light fidelity (Li-Fi) network, a local area network (LAN), a wide area network (WAN), a metropolitan area network (MAN), a satellite network, the Internet, a fiber optic network, a coaxial cable network, an infrared (IR) network, a radio frequency (RF) network, a virtual network, and/or another suitable public and/or private network capable of supporting communication among two or more of the parts or users illustrated in FIG. 2, or any combination thereof.

Various entities in the environment 200 may connect to the network 204 in accordance with various wired and wireless communication protocols, such as Transmission Control Protocol and Internet Protocol (TCP/IP), User Datagram Protocol (UDP), 2nd Generation (2G), 3rd Generation (3G), 4th Generation (4G), 5th Generation (5G) communication protocols, Long Term Evolution (LTE) communication protocols, New Radio (NR) communication protocol, any future communication protocol, or any combination thereof. In some instances, the network 204 may utilize a secure protocol (e.g., Hypertext Transfer Protocol (HTTP), Secure Socket Lock (SSL), and/or any other protocol, or set of protocols for communicating with the various entities depicted in FIG. 2.

In an embodiment, the client 102 may refer to an individual or entity that performs an activity or event for which a task-specific prediction has to be generated. The term ‘event’ may refer to any action for which a prediction has been generated. In various examples, the event may refer to a transaction, social media interaction, a sale, a diagnosis, and so on.

As described earlier, due to the time-consuming and complex process of generating embeddings for an event, their use in time-sensitive applications requiring low latency is not possible. Further, the conventional approach of using static embeddings instead of actual real-time embeddings is unable to deliver satisfactory results or performance.

The above-mentioned technical problems, among other problems, are addressed by one or more embodiments implemented by the server system 102 and methods thereof provided in the present disclosure.

In one embodiment, the server system 102 is configured to predict a real-time embedding for a real-time event. In an embodiment, the server system 102 is configured to receive an embedding generation request for the real-time event from the client 202. For instance, a social media interaction takes place between user A and user B of a social media platform, and the client 104 associated with the social media platform wishes to predict the duration of the real-time interaction (i.e., the real-time event) between these users. To achieve this, the client may request the server system 102 to determine the interaction duration using a down-stream task model trained to determine the duration of such interactions.

Upon receiving this request, the server system 102 may access a static embedding, a set of velocity features, and a set of real-time velocity features from the database 116 associated with the server system. It is noted that terms ‘static embedding’, ‘set of velocity features’ and ‘the set of real-time velocity features’ have been described earlier. Then, the server system is configured to compute a difference between the set of real-time velocity features and the set of velocity features. As may be understood, the difference between the real-time velocity features and the velocity features used for generating the static embedding represents the overall change in each individual velocity feature from the set of velocity features at the instance when the real-time event takes place. Further, the server system is configured to generate a real-time embedding prediction for the real-time event based, at least in part, on the static embedding, the set of velocity features, and the computed difference.

As may be appreciated, utilizing the real-time embedding prediction by a down-stream task model instead of the actual real-time embedding significantly reduces the computational resources or time required for performing predictions by the down-stream task model. Additionally, since the real-time embedding prediction is a close estimate of the actual real-time embedding, the performance of the down-stream task model is significantly improved as well when compared with results generated using the static embedding.

The number and arrangement of systems, devices, and/or networks shown in FIG. 2 are provided as an example. There may be additional systems, devices, and/or networks; fewer systems, devices, and/or networks; different systems, devices, and/or networks; and/or differently arranged systems, devices, and/or networks than those shown in FIG. 2. Furthermore, two or more systems or devices shown in FIG. 2 may be implemented within a single system or device, or a single system or device is shown in FIG. 2 may be implemented as multiple, distributed systems or devices. In addition, the server system 102 should be understood to be embodied in at least one computing device in communication with the network 204, which may be specifically configured, via executable instructions, to perform steps as described herein, and/or embodied in at least one non-transitory computer-readable media.

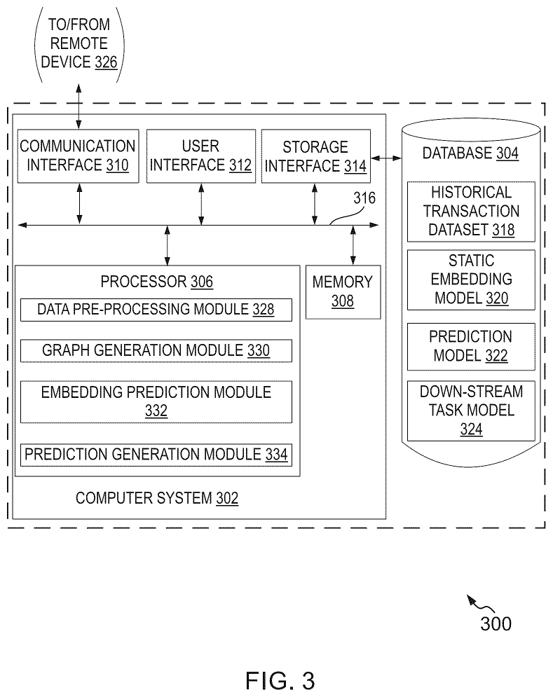

FIG. 3 illustrates a simplified block diagram of a server system 300, in accordance with an embodiment of the present disclosure. The server system 300 is identical to the server system 102 of FIG. 1 and FIG. 2. In one embodiment, the server system 300 can be a part of the payment network 112 or integrated within the payment server 114. In some embodiments, the server system 300 is embodied as a cloud-based and/or Saas (software as a service) based architecture.

The server system 300 includes a computer system 302 and a database 304. The computer system 302 includes at least one processor 306 for executing instructions, a memory 308, a communication interface 310, a user interface 312, and a storage interface 314. The one or more components of the computer system 302 communicate with each other via a bus 316. The components of the server system 300 provided herein may not be exhaustive and the server system 300 may include more or fewer components than those depicted in FIG. 3. Further, two or more components depicted in FIG. 3 may be embodied in one single component, and/or one component may be configured using multiple sub-components to achieve the desired functionalities.

In some embodiments, the database 304 is integrated into the computer system 302. In one non-limiting example, the database 304 is configured to store a historical transaction dataset 318, a static embedding model 320, a prediction model 322, and a down-stream task model 324 among other relevant instructions for operating the server system 300. Herein, the prediction model 322 is identical to the prediction model 120 of FIG. 1 In an embodiment, the computer system 302 may include one or more hard disk drives as the database 304. The user interface 312 is an interface such as a Human Machine Interface (HMI) or a software application that allows users such as an administrator (not shown) to interact with and control the server system 300 or one or more parameters associated with the server system 300. It may be noted that the user interface 312 may be composed of several components that vary based on the complexity and purpose of the application. Examples of components of the user interface 312 may include visual elements, controls, navigation, feedback and alerts, user input and interaction, responsive design, user assistance and help, accessibility features, and the like. More specifically, these components may correspond to icons, layout, color schemes, buttons, sliders, dropdown menus, tabs, links, error/success messages, mouse and touch interactions, keyboard shortcuts, tooltips, screen readers, and the like.

In an embodiment, the storage interface 314 is any component capable of providing the processor 306 access to the database 304. The storage interface 314 may include, for example, an Advanced Technology Attachment (ATA) adapter, a Serial ATA (SATA) adapter, a Small Computer System Interface (SCSI) adapter, a RAID controller, a Storage Area Network (SAN) adapter, a network adapter, and/or any component providing the processor 306 with access to the database 304.

The processor 306 includes suitable logic, circuitry, and/or interfaces to execute operations for predicting a real-time embedding for a real-time event such as a payment transaction between a cardholder such as cardholder 104(1) and a merchant 106(1), and the like. Examples of the processor 306 include, but are not limited to, an application-specific integrated circuit (ASIC) processor, a reduced instruction set computing (RISC) processor, a graphical processing unit (GPU), a complex instruction set computing (CISC) processor, a field-programmable gate array (FPGA), and the like.

The memory 308 includes suitable logic, circuitry, and/or interfaces to store a set of computer-readable instructions for performing various operations described herein. Examples of the memory 308 include a random-access memory (RAM), a read-only memory (ROM), a removable storage drive, a hard disk drive (HDD), and the like. It will be apparent to a person skilled in the art that the scope of the disclosure is not limited to realizing the memory 308 in the server system 300, as described herein. In another embodiment, the memory 308 may be realized in the form of a database server or a cloud storage working in conjunction with the server system 300, without departing from the scope of the present disclosure.

The processor 306 is operatively coupled to the communication interface 310, such that the processor 306 is capable of communicating with a remote device 326 such as the issuer servers 108, the acquirer servers 110, the payment server 114, the client 202, or communicating with any entity connected to the network 118 (as shown in FIG. 1) or network 204 (as shown in FIG. 2).

It is noted that the server system 300 as illustrated and hereinafter described is merely illustrative of an apparatus that could benefit from embodiments of the present disclosure and, therefore, should not be taken to limit the scope of the present disclosure. It is noted that the server system 300 may include fewer or more components than those depicted in FIG. 3.

In one implementation, the processor 306 includes a data pre-processing module 328, a graph generation module 330, an embedding prediction module 332, and a prediction generation module 334 in reference to FIG. 3. It should be noted that components, described herein, such as the data pre-processing module 328, the graph generation module 330, the embedding prediction module 332, and the prediction generation module 334 can be configured in a variety of ways, including electronic circuitries, digital arithmetic, and logic blocks, and memory systems in combination with software, firmware, and embedded technologies.

In an embodiment, the data pre-processing module 328 includes suitable logic and/or interfaces for receiving an embedding generation request for the real-time event. The embedding generation request may include information or attributes related to the real-time event. In an exemplary scenario, the real-time event can be a real-time transaction, i.e., performed between the cardholder 104(1) and the merchant 106(1).

For instance, the cardholder 104(1) may perform a transaction at the merchant 106(1) with a payment card. The merchant 106(1) may utilize a POS device to process the transaction, the POS device transmits the payment card information along with relevant authentication information to the acquirer server 110(1). Then, the acquirer server 110(1) transmits a payment authorization request message to the issuer server 108(1). Upon receiving the payment authorization request message, the issuer server 108(1) may wish to determine the likelihood of the transaction being a fraud in the future in real-time before authorizing the said transaction. To achieve this, the issuer server 108(1) can transmit the embedding generation request for the real-time transaction to the data pre-processing module 328 of the server system 300. Further, the embedding generation request may include one or more transaction attributes associated with the real-time transaction. In various non-limiting examples, the one or more transaction attributes may include transaction-related information, such as transaction amount, source of funds such as bank or credit cards, transaction channel used for loading funds such as POS terminal or ATM, transaction location information, Card Present (CP) indicator, Card Not Present (CNP) indicator, external data sources, merchant country, merchant Identifier (ID), cardholder ID, cardholder product, cardholder Permanent Account Number (PAN), Merchant Category Code (MCC), merchant location data or merchant co-ordinates, merchant name, city, zip code merchant industry, merchant super industry, ticket price or ticket Size, number of unique cards, location, transaction channel (POS/Ecomm/Cash), product code, transaction mode, and other transaction-related data.

In another embodiment, the data pre-processing module 328 is configured to generate a set of real-time velocity features. In particular, the data pre-processing module 328 is configured to generate one or more real-time event-related features based, at least in part, on the attributes related to the real-time event extracted from the embedding generation request. Then, the data pre-processing module 328 is configured to generate the set of real-time velocity features based, at least in part, on the one or more real-time event-related features. In some instances, the data pre-processing module 328 may utilize existing featurization techniques for generating the various features described herein. The featurization techniques may include one-hot encoding, logarithmic transformation, binning, and so on. It is noted that since these techniques are well-known in the art, they have not been explained here for the sake of brevity. Some examples of the real-time velocity features include cardholder with a given merchant authorized transaction count, transaction amount, total transaction count, card fraud rate, cross-border transactions, CNP transactions in the past ‘x’ number of days for a particular cardholder with different merchants, and so on.

Further, the set of real-time velocity features is stored in the database 304. These real-time velocity features may be accessed from the database 304 later on as required. In some instances, the data pre-processing module 328 is configured to access the real-time velocity features from the database 304.

Returning to the previous exemplary scenario, the set of real-time velocity features can be generated for the payment transaction. In particular, one or more real-time transaction features are extracted from the embedding generation request for the real-time transaction. Then, the set of real-time velocity features is generated based on the one or more real-time transaction features and stored in the database 304.

In an embodiment, the data pre-processing module 328 is configured to generate a set of velocity features. In particular, data pre-processing module 328 is configured to access a historical dataset from the database 304. The historical dataset may include a plurality of attributes associated with a series of historical events such that each historical event from the series of historical events is performed by a plurality of entities. Then, a set of historical event features is generated for the series of historical events based, at least, in part, on the plurality of attributes.

Returning to the previous exemplary scenario, to generate the set of velocity features for a transaction, a historical transaction dataset from the database 304. The historical transaction dataset 318 may include a plurality of transaction attributes associated with each of a plurality of transactions performed between a plurality of cardholders 104 and a plurality of merchants 106 over a historical period. The historical period may refer to 1 month, 3 months, 9 months or so on. The historical transaction dataset 318 may be updated with attributes related to new transactions when they take place as well. In various non-limiting examples, the plurality of transaction attributes may include transaction-related information, such as transaction amount, source of funds such as bank or credit cards, transaction channel used for loading funds such as POS terminal or ATM, transaction location information, Card Present (CP) indicator, Card Not Present (CNP) indicator, external data sources, merchant country, merchant Identifier (ID), cardholder ID, cardholder product, cardholder Permanent Account Number (PAN), Merchant Category Code (MCC), merchant location data or merchant co-ordinates, merchant name, city, zip code merchant industry, merchant super industry, ticket price or ticket Size, number of unique cards, location, transaction channel (POS/Ecomm/Cash), product code, transaction mode, and other transaction-related data. It is noted that the attribute types associated with the real-time transaction and the historical transactions will be identical however, the values associated with these attributes will be different. Then, the data pre-processing module 328 generates a set of cardholder features for each cardholder and a set of merchant features for each merchant based, at least, in part, on the plurality of transaction attributes. Examples of the cardholder features include card authorized transaction count, transaction amount, total transaction count, card fraud rate, cross-border transactions, CNP transactions in the past ‘x’ number of days to a particular user or merchant, and so on. Examples of the merchant features include merchant authorized transaction count, transaction amount, total transaction count, card fraud rate, cross-border transactions, CNP transactions in the past ‘x’number of days with a particular user or cardholder, and so on.

Thereafter, the data pre-processing module 328 utilizes the graph generation module 330 that includes suitable logic and/or interfaces for generating an event-specific graph based, at least in part, on the set of historical event features. The event-specific graph may include a set of entity nodes corresponding to the plurality of entities. The set of entity nodes are connected with a plurality of edges. Herein, each edge indicates a relationship between distinct entity nodes from the set of entity nodes. In some instances, the event-specific graph may be a heterogeneous graph such as a K-partite graph generated for K number of entities (where, K is a non-zero natural number) or a homogeneous graph. The term ‘heterogeneous graph’ refers to graph structures that represent a relationship between two different nodes of different types and the term ‘homogeneous graph’ refers to graph structures that represent a relationship between different nodes of the same type.

Returning to the previous exemplary scenario, a bipartite graph is generated for the plurality of transactions based, at least in part, on the set of cardholder features for each cardholder and the set of merchant features for each merchant. The term ‘bipartite graph’ refers to versatile graph structures that represent a relationship between two distinct types of nodes. It is noted that bipartite graphs have a wide range of applicability in real-world scenarios. For instance, in recommender systems, users and items can be defined as two types of nodes within a bipartite graph. In this instance, the edges between the distinct nodes within the bipartite graph will represent interactions between the users and items. For example, in the financial domain, the bipartite graph may be generated for the plurality of cardholders 104 and the plurality of merchants 106. In this example, the bipartite graph may be called a cardholder-merchant bipartite graph or merchant-cardholder bipartite graph. The bipartite graph may include a set of cardholder nodes associated with the plurality of cardholders and a set of merchant nodes associated with the plurality of merchants. Within the bipartite graph, the set of cardholder nodes and the set of merchant nodes are connected with a plurality of edges such that each edge indicates a transaction performed between a particular cardholder node and a particular merchant node. In another example, the bipartite graph may be generated for the plurality of acquirers 110 and the plurality of issuers 108. In this example, the bipartite graph may be called an acquirer-issuer bipartite graph or an issuer-acquirer bipartite graph. In a non-limiting example, the graph generation module 330 identifies the cardholders 104(1)-104(3) that have made payment transactions with the merchants 106(1)-106(3) based at least on the information related to historical payment transactions between the plurality of cardholders 104 and the plurality of merchants 106. More specifically, a cardholder-merchant bipartite graph may be generated by representing the cardholders 104(1)-104(3) and the merchants 106(1)-106(3) as nodes of different types and connecting these nodes a set of edges that represent a transaction between the distinct nodes. It is noted that each node is associated with its corresponding features, e.g., cardholder nodes are associated with their corresponding cardholder features.

Further, the data pre-processing module 328 is configured to generate the set of velocity features based, at least in part, on the entity-specific graph. Thereafter, the set of velocity features is stored in the database 304. These velocity features may be accessed from the database 304 later on as required. In some instances, the data pre-processing module 328 is configured to access the velocity features from the database 304.

Returning to the previous exemplary scenario, a set of cardholder velocity features are generated for the cardholder and a set of merchant velocity features are generated for the merchant based, at least in part, on the bipartite graph. Further, the set of velocity features is stored in the database 304.

In another embodiment, the data pre-processing module 328 is configured to generate a static embedding based, at least in part, on the set of velocity features. In an implementation, the static embedding model 320 can be utilized by the data pre-processing module 328 to generate the static embedding. Examples of the static embedding model 320 include a Temporal Graph Network (TGN) model, Dynamic Graph Embedding (DyANE) model, Dynamic Graph Representation Learning (DGRL) model, Graph Recurrent Neural Network (GRNN) model, Temporal Graph Convolutional Network (TGCN), Evolutionary Graph Convolutional Network (EvolveGCN) model, Spatio-Temporal Graph Convolutional Network (ST-GCN) and so on. For the sake of simplicity, the static embedding model 320 is assumed to be a TGN model however, other models may also be used to generate the static embedding.

Returning to the previous exemplary scenario, the static embedding model 320 generates a static embedding based, at least in part, on the set of velocity features. In an instance, the static embedding may be generated for the velocity features corresponding to the cardholder 104, the merchant 106, or velocity features that are a combination of the velocity features of the cardholder 104 and the merchant 106. Then, the static embedding is stored in the database 304. The static embedding model 320 analyzes the temporal information (such as transaction time stamps or sequences) within the bipartite graph, to learn the evolving relationships between cardholders 104 and merchants 106 over time. Then, the static embedding model 320 learns an embedding for each node in the bipartite graph that incorporate both the structural and temporal information associated with each node.

Then, the learned embeddings are extracted for the cardholder and the merchant nodes. This process is performed for all the nodes in the bipartite graph. In an example, the static embedding of cardholder node captures its interactions with different merchants over time. On the other hand, the static embedding of the merchant node captures its interactions with different cardholders over time. Since, the process of generating these embeddings is time-consuming due to the complexity of analyzing millions of transactions, generally these embeddings are generated to remain static for a predefined time duration, that's why these embeddings are called static embeddings. The predefined time duration may be a week, two weeks or so on. The predefined time duration may be defined by an administrator (not shown) of the server system 300 based on the requirements of down-stream task. Examples of down-stream tasks include fraud detection, customer segmentation, recommendation systems and the like. Further, the static embedding is stored in the database 304. After the predefined time duration, the static embedding can be updated by the static embedding model 320 and updated in the database 304. This static embedding may be accessed from the database 304 later on as required. In some instances, the data pre-processing module 328 is configured to access the static embedding from the database 304.

In another embodiment, the data pre-processing module 328 is configured to compute a performance value of a static embedding model based, at least in part, on one or more performance metrics. Then, the data pre-processing module 328 is configured to re-train the static embedding model upon determining that the performance value is lower than a performance threshold value. The performance threshold value may be defined by the administrator (not shown) of the server system 300 based on the requirements of down-stream task. In other words, if the performance of the static embedding falls below the performance threshold value, an updated or new static embedding for each node in the bipartite graph is generated.

In an embodiment, the embedding prediction module 332 includes suitable logic and/or interfaces for computing a difference between the set of real-time velocity features and the set of velocity features. As may be understood, the difference between the real-time velocity features and the velocity features used for generating the static embedding represents the overall change in each individual velocity feature from the set of velocity features at the instance when the real-time transaction takes place. In other words, the computed difference helps the prediction model 322 understand how the velocities have evolved hence, helping the prediction model 322 such as an autoencoder model in correctly predicting the change in the real-time embedding.

Then, the embedding prediction module 332 is configured to generate a real-time embedding prediction for the real-time event based, at least in part, on the static embedding, the set of velocity features, and the computed difference. In an implementation, the prediction model 322 can be utilized by the embedding prediction module 328 for generating the real-time embedding prediction.

In various non-limiting examples, the prediction model 322 may include an autoencoder (AE) model, a variational autoencoder (VAE) model, generative adversarial networks (GANs), and the like. For the sake of simplicity, the prediction model 322 is assumed to be an autoencoder model however, other models may also be used to implement the prediction model 120. The autoencoder model is a neural network model that consists of input layers, hidden layers and an output layer. The autoencoder is trained to generate an embedding or encoding of the input data and using it decode or reconstruct the input data. This is a self-supervised process in which the input data serves as both the input and target output during the training.

In an exemplary scenario, the static embedding at the start of a week may be represented by E₀, the velocity features used to compute E₀ may be represented by V₀, and V₁ may represent the real-time velocity features of a real-time transaction T₁. Similarly, for subsequent transactions performed within the same week, i.e., T₂, T₃, and T₄, the real-time velocity may be represented by V₂, V₃, and V₄ respectively. In this scenario, the embedding prediction module 332 may compute the differences between the velocity features and the real-time features for corresponding transactions, i.e., V₁-V₀, V₂-V₀, V₃-V₀, and V₄-V₀. Thereafter, the embedding prediction module 332 generates the real-time embedding prediction, i.e., E₁ for transaction T₁ using the static embedding (i.e., E₀), the velocity features (i.e., V₀), and the computed difference (i.e., V₁-V₀). Similarly, real-time embedding predictions E₂, E₃, and E₄ for corresponding transactions T₂, T₃, and T₄ can be generated as well.

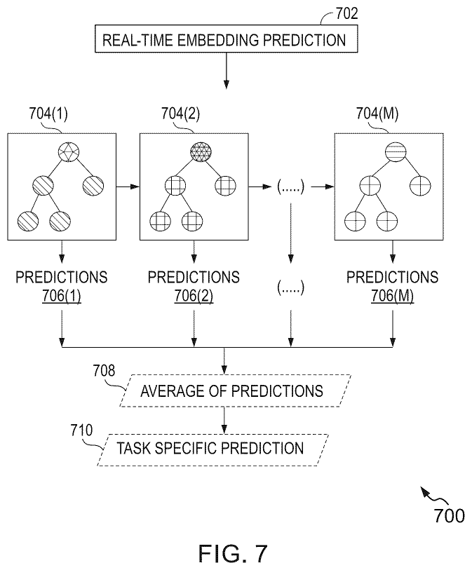

In an embodiment, the prediction generation module 334 includes suitable logic and/or interfaces for receiving a prediction request associated with a down-stream task. Then, the prediction generation module 334 is configured to generate a task-specific prediction for the down-stream task based, at least in part, on the real-time embedding prediction. In an implementation, the down-stream task model 324 can be utilized by the prediction generation module 334 for generating the task-specific prediction. Examples of the down-stream task model 324 include Decision Tree based ML models or algorithms such as eXtreme Gradient Boosting (XGBoost), Categorical Boosting (Catboost) model, Light Gradient Boosting Machines (LightGBM) model, Random Forest model, Deep Neural Network (DNN) models, and the like. This aspect has been described later with reference to FIG. 7.

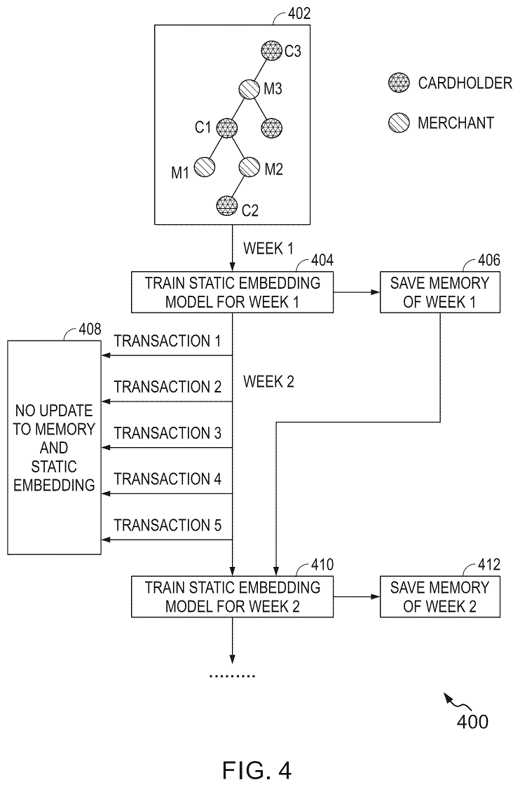

FIG. 4 illustrates a schematic representation of a process 400 for generating a static embedding for a transaction, in accordance with an embodiment of the present disclosure.

For generating the static embedding, the graph generation module 330 of the server system 300 is configured to generate an event-specific graph. In an implementation, the static embedding may be generated using a plurality of transactions performed between cardholders (such as C₁, C₂, and C₃) and merchants (such as M₁, M₂, and M₃). In this implementation, the graph generation module 330 of the server system 300 is configured to generate a bipartite graph 402. Then, the server system 300 is configured to train the static embedding model 320 such as the TGN model to generate the static embedding for a predefined time duration such as a week (see 404, train the static embedding model for week 1) using the set of velocity features. Later, the static embedding is stored in the memory or database 304 (see, 406). Now, as per the conventional approach, for transactions performed during a week by the cardholder (such as transaction 1, transaction 2, . . . transaction 5), the same static embedding is utilized by the down-stream task model 334 to perform a task-specific prediction for the down-stream task. Further, after each transaction is performed, no update is done to the memory and the static embedding (see, 408). This process can be performed repeatedly to generate the static embeddings for the subsequent weeks (see, steps 410 and 412).

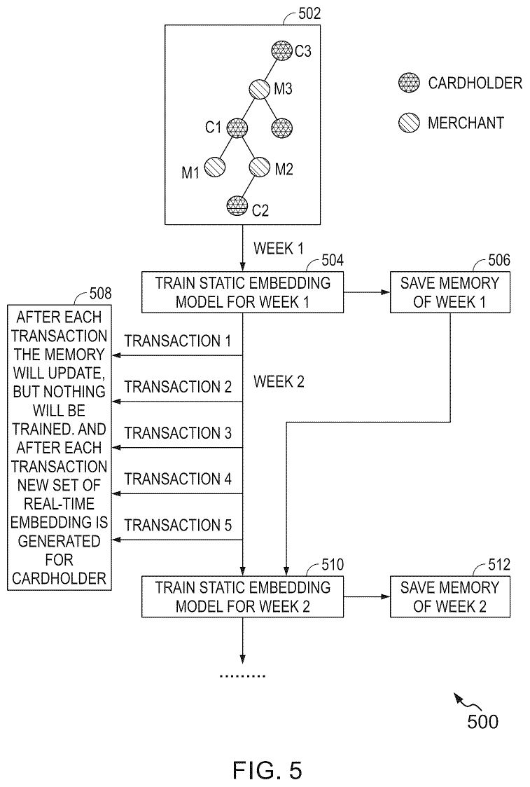

FIG. 5 illustrates a schematic representation of a process 500 for generating a real-time embedding prediction for a real-time transaction, in accordance with an embodiment of the present disclosure. It is noted that the process for generating the real-time embedding prediction involves various steps described previously with reference to FIG. 4, therefore these steps (see, 502, 504, 506, 510, and 512) are not explained again for the sake of brevity.

For generating the real-time embedding prediction, the graph generation module 330 of the server system 300 is configured to generate an event-specific graph. In an implementation, the graph generation module 330 of the server system 300 is configured to generate a bipartite graph 502. Then, the server system 300 is configured to train the static embedding model 320 such as the TGN model to generate the static embedding for a predefined time duration such as a week (see 504, train the static embedding model for week 1). Later, the static embedding is stored in the memory or database 304 (see, 506).

Now, for each transaction performed during a week by the cardholder (such as transaction 1, transaction 2, . . . transaction 5), a real-time embedding prediction is generated for the cardholder (C₁-C₃). To generate the real-time embedding, the static embedding and the computed difference between the set of velocity features used for generating the static embedding at 504 and the set of real-time velocity features are fed as inputs to the prediction model 322. Then, the prediction model 322 outputs the real-time embedding prediction.

This real-time embedding prediction for each transaction can be utilized by the down-stream task model 324 to perform a task-specific prediction for the down-stream task. Further, after each transaction is performed, the memory is updated, and a new real-time embedding is generated for the cardholder (see, 508). This process can be performed repeatedly to generate the static embeddings and the real-time embedding prediction for the subsequent weeks (see, steps 510 and 512).

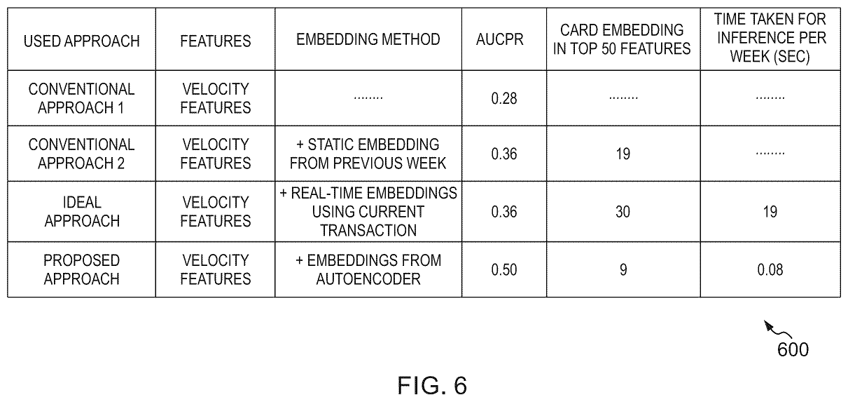

FIG. 6 illustrates a table 600 indicating various experimental results, in accordance with an embodiment of the present disclosure.

To assess the performance of the proposed approach described in the present disclosure, an experiment has been conducted. The goal of the experiment is to compare conventional approaches (i.e., the conventional approach 1 and conventional approach 2) and the ideal approach with the proposed approach. For experimentation, the time required for performing a down-stream task, i.e., fraud detection task, and the Area Under the Precision-Recall Curve (AUCPR) of the down-stream task model (i.e., the fraud detection model) are used to assess the performance of the proposed approach. This assessment is performed on a sample dataset of approximately 25,000 transactions conducted over one week. The results of the experiment are shown in Table 600 of FIG. 6. It is noted that the results of the experiment shown in Table 600 are approximate and may vary about ±5 to 10 % if the experiment is reproduced again.

Herein, the conventional approach 1 considers the set of velocity features for generating an embedding for generating a task-specific prediction, i.e., whether the transaction is fraudulent or non-fraudulent. The conventional approach 2 considers the static embedding from the previous week along with the velocity features and the real-time velocity features for generating an embedding for generating a task-specific prediction. The ideal approach considers the actual real-time embeddings generated using the real-time transaction and the real-time velocity features for generating an embedding for generating a task-specific prediction. It is noted that the ideal approach has the highest AUCPR, i.e., 0.59 since it's the ideal scenario. However, the ideal approach is quite time-consuming as well. As illustrated in Table 600, the ideal approach takes about 19 seconds to generate inference from the 25,000 transactions within one week using the fraud detection model.

On the other hand, the proposed approach considers the real-time embedding prediction (i.e., embeddings from the autoencoder model) and the real-time velocity features for generating a task-specific prediction while consuming the least time. As illustrated in Table 600, the proposed approach takes about 0.08 seconds to infer the 25,000 transactions within one week while maintaining an AUCPR of 0.50, which is quite similar to the AUCPR of the ideal approach. As may be appreciated, since the proposed approach provides similar performance to the ideal scenario while consuming a fraction of time, the proposed approach can be utilized in applications where real-time (or near real-time) predictions have to be performed.

FIG. 7 illustrates a schematic representation of a process 700 for generating predictions using the down-stream task model, in accordance with an embodiment of the present disclosure.

As described earlier, the down-stream task model may be a Gradient Boosting Machine (GBM) model or eXtreme Gradient Boosting (XGBoost) model. Additionally, the XGBoost model is configured to perform fraud detection (i.e., the down-stream task) for payment transactions. It is noted that for the sake of explanation, although, the down-stream task model is considered as an XGBoost model, the same should not be construed as a limitation. To that end, the down-stream task model can be any classification model.

As used herein, “Gradient Boosting” refers to a popular boosting algorithm in machine learning used for classification and regression tasks. It may be noted that boosting is one kind of ensemble learning method that trains the model sequentially and each new model tries to correct the previous model. It combines several weak learners into strong learners. Similarly, as used herein, the term “extreme gradient boosting” refers to a type of boosting algorithm in machine learning that is similar to the GBM model, however, the difference is in model details, for example, the XGBoost model in comparison to the GBM model is more regularized model formalization to control a problem of over-fitting, which gives a better performance.

As may be understood, the XGBoost model is a scalable tree-boosting system that can solve real-world problems with remarkable performance using minimal resources. Herein, the XGBoost model receives the real-time embedding prediction 702 from the embedding prediction module 332 of the server system 300 as an input.

In an instance, the XGBoost model may be trained using a portion of embeddings generated using the historical transaction dataset 318 and the actual labels (such as fraud or non-fraud labels) associated with the transactions. The goal of the training process is to ensure that the XGBoost model learns the patterns in the input and can perform predictions for a new input. Further, upon completion of the training process, the XGBoost model can be tested using another portion of embeddings generated using the historical transaction dataset 318. The goal of the testing process is to ensure whether the XGBoost model is functioning as per its purpose of training or not.

In a non-limiting implementation, the XGBoost model produces individual decision trees (e.g., decision trees 704(1), 704(2), . . . 704(M) where ‘M’ is a non-zero Natural number, hereinafter, interchangeably referred to as decision trees 704 sequentially. Here, a subset of the training data for each subsequent tree (e.g., the decision tree 704(2) is chosen based on the performance of the previous decision trees (e.g., the decision tree 704(1)), as shown in FIG. 7. More specifically, each decision tree is trained on the examples that were incorrectly classified by the previous classifiers.

It may be noted that the XGBoost model uses a second-order gradient boosting technique based on the gradient descent algorithm which aims to minimize the loss when adding new models or decision trees. Therefore, each new decision tree corrects the errors made by the previous decision trees. This will finally produce ‘M’ decision trees, where ‘M’ depends on the number of predetermined iterations for the algorithm, which provide ‘M’ predictions 706(1), 706(2), . . . 706(M), hereinafter, interchangeably referred to as predictions 706.

Further, the final classification is made by combining the outputs (e.g., the predictions 706) of all the classifiers (decision trees) with the chosen weighting and averaging method. In other words, it may be noted that an average of the predictions 706 (see, 708) may be performed by the XGBoost model for obtaining a final prediction, i.e., task-specific prediction 710 as shown in FIG. 7.

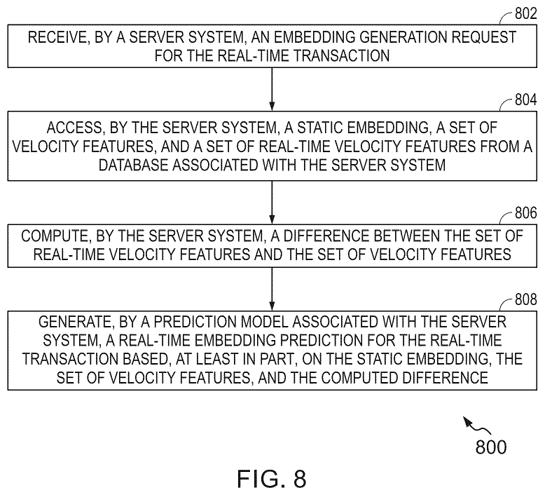

FIG. 8 illustrates a process flow diagram depicting a method 800 for predicting a real-time embedding for a real-time transaction between a cardholder and a merchant, in accordance with an embodiment of the present disclosure. The method 800 depicted in the flow diagram may be executed by, for example, the server system 300. The sequence of operations of the method 800 may not be necessarily executed in the same order as they are presented. Further, one or more operations may be grouped and performed in the form of a single step, or one operation may have several sub-steps that may be performed in parallel or in a sequential manner. Operations of the method 800, and combinations of operations in the method 800 may be implemented by, for example, hardware, firmware, a processor, circuitry, and/or a different device associated with the execution of software that includes one or more computer program instructions. The plurality of operations is depicted in the process flow of the method 800. The process flow starts at operation 802.

At 802, the method 800 includes receiving, by a server system (e.g., the server system 300), an embedding generation request for the real-time transaction between a cardholder and a merchant.

At 804, the method 800 includes accessing, by the server system 300, a static embedding, a set of velocity features, and a set of real-time velocity features from a database 304 associated with the server system 300.

At 806, the method 800 includes computing, by the server system 300, a difference between the set of real-time velocity features and the set of velocity features.

At 808, the method 800 includes generating, by a prediction model associated with the server system 300, a real-time embedding prediction for the real-time transaction based, at least in part, on the static embedding, the set of velocity features, and the computed difference.

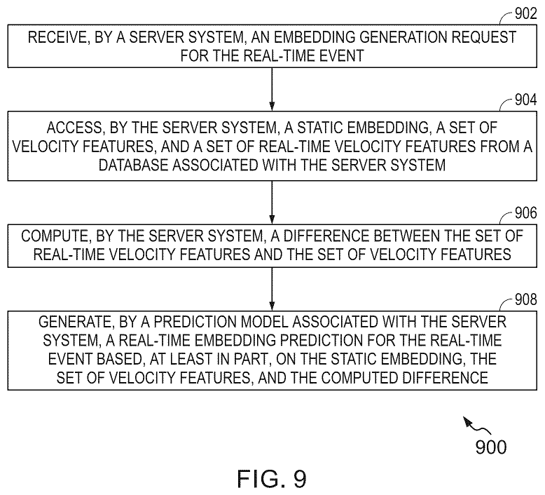

FIG. 9 illustrates a process flow diagram depicting a method 900 for predicting a real-time embedding for a real-time event, in accordance with an embodiment of the present disclosure. The method 900 depicted in the flow diagram may be executed by, for example, the server system 300. The sequence of operations of the method 900 may not be necessarily executed in the same order as they are presented. Further, one or more operations may be grouped and performed in the form of a single step, or one operation may have several sub-steps that may be performed in parallel or in a sequential manner. Operations of the method 900, and combinations of operations in the method 900 may be implemented by, for example, hardware, firmware, a processor, circuitry, and/or a different device associated with the execution of software that includes one or more computer program instructions. The plurality of operations is depicted in the process flow of the method 900. The process flow starts at operation 902.

At 902, the method 900 includes receiving, by a server system (e.g., the server system 300), an embedding generation request for the real-time event.

At 904, the method 900 includes accessing, by the server system 300, a static embedding, a set of velocity features, and a set of real-time velocity features from a database 304 associated with the server system 300.

At 906, the method 900 includes computing, by the server system 300, a difference between the set of real-time velocity features and the set of velocity features.

At 908, the method 900 includes generating, by a prediction model associated with the server system 300, a real-time embedding prediction for the real-time event based, at least in part, on the static embedding, the set of velocity features, and the computed difference.

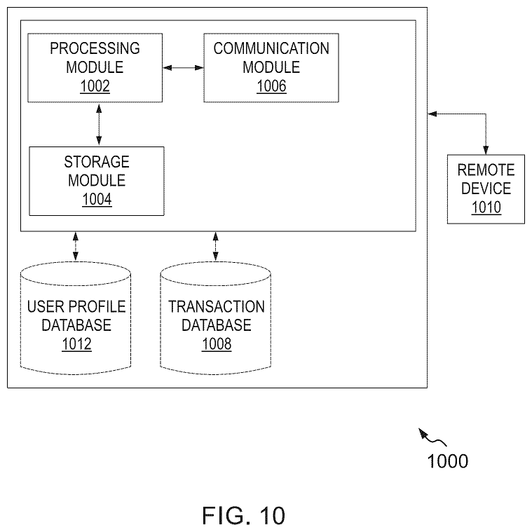

FIG. 10 illustrates a simplified block diagram of an acquirer server 1000, in accordance with an embodiment of the present disclosure. The acquirer server 1000 is an example of the acquirer servers 110 of FIG. 1. The acquirer server 1000 is associated with an acquirer bank/acquirer, in which a merchant 106(1) may have an account, which provides a payment card. The acquirer server 1000 includes a processing module 1002 operatively coupled to a storage module 1004 and a communication module 1006. The components of the acquirer server 1000 provided herein may not be exhaustive, and the acquirer server 1000 may include more or fewer components than those depicted in FIG. 10. Further, two or more components may be embodied in one single component, and/or one component may be configured using multiple sub-components to achieve the desired functionalities. Some components of the acquirer server 1000 may be configured using hardware elements, software elements, firmware elements, and/or a combination thereof.

The storage module 1004 is configured to store machine-executable instructions to be accessed by the processing module 1002. Additionally, the storage module 1004 stores information related to, the contact information of the merchant 106(1), bank account number, availability of funds in the account, payment card details, transaction details, and/or the like. Further, the storage module 1004 is configured to store transactions associated with the merchant 106(1).

In one embodiment, the acquirer server 1000 is configured to store profile data (e.g., an account balance, a credit line, details of the merchants 106, account identification information, and a payment card number) in a transaction database 1008. The details of the merchants 106 may include, but are not limited to, name, age, gender, physical attributes, location, registered contact number, family information, alternate contact number, registered e-mail address, etc.

The processing module 1002 is configured to communicate with one or more remote devices such as a remote device 1010 using the communication module 1006 over a network such as the network 118 of FIG. 1. The examples of the remote device 1010 include the server system 102, the payment server 114, the issuer servers 108, or other computing systems of the acquirer server 1000, and the like. The communication module 1006 can facilitate such operative communication with the remote devices and cloud servers using Application Program Interface (API) calls. The communication module 106 is configured to receive a payment transaction request performed by the cardholders 104 via the network 118. The processing module 1002 receives payment card information, a payment transaction amount, cardholder information, and merchant information from the remote device 1010 (i.e., the payment server 114). The acquirer server 1000 includes a user profile database 1012 and the transaction database 1008 for storing transaction data. The user profile database 1012 may include information about the merchants 106. The transaction data may include, but is not limited to, transaction attributes, such as transaction amount, source of funds such as bank or credit cards, transaction channel used for loading funds such as POS terminal or ATM, transaction velocity features such as count and transaction amount sent in the past x days to a particular user, transaction location information, external data sources, pre-auth transactions, failed transactions, disputed transactions, non-cleared transactions and other internal data to evaluate each transaction.

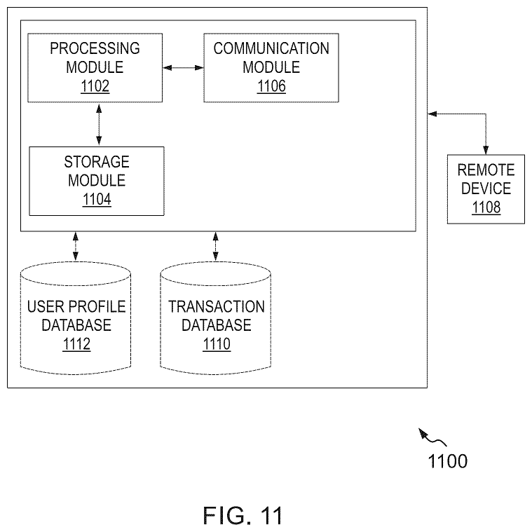

FIG. 11 illustrates a simplified block diagram of an issuer server 1100, in accordance with an embodiment of the present disclosure. The issuer server 1100 is an example of any issuer server such as issuer server 108(1) from the issuer servers 108 of FIG. 1. The issuer server 1100 is associated with an issuer bank/issuer, in which an account holder (e.g., the cardholders 104(1)-104(N)) may have an account, which provides a payment card. The issuer server 1100 includes a processing module 1102 operatively coupled to a storage module 1104 and a communication module 1106. The components of the issuer server 1100 provided herein may not be exhaustive and the issuer server 1100 may include more or fewer components than those depicted in FIG. 11. Further, two or more components may be embodied in one single component, and/or one component may be configured using multiple sub-components to achieve the desired functionalities. Some components of the issuer server 1100 may be configured using hardware elements, software elements, firmware elements, and/or a combination thereof.

The storage module 1104 is configured to store machine-executable instructions to be accessed by the processing module 1102. Additionally, the storage module 1104 stores information related to, the contact information of the cardholders (e.g., the cardholders 104(1)-104(N)), a bank account number, availability of funds in the account, payment card details, transaction details, payment account details, and/or the like. Further, the storage module 1104 is configured to store transactions associated with the cardholders 104.

In one embodiment, the issuer server 1100 is configured to store profile data (e.g., an account balance, a credit line, details of the cardholders 104, account identification information, payment card number, etc.) in a database. The details of the cardholders 104 may include but are not limited to, name, age, gender, physical attributes, location, registered contact number, family information, alternate contact number, registered e-mail address, or the like of the cardholders 104.

The processing module 1102 is configured to communicate with one or more remote devices such as a remote device 1108 using the communication module 1106 over a network such as the network 118 of FIG. 1. Examples of the remote device 1108 include the server system 300, the payment server 114, the acquirer servers 110 or other computing systems of the issuer server 1100. The communication module 1106 can facilitate such operative communication with the remote devices 1108 and cloud servers using Application Program Interface (API) calls. The communication module 1106 is configured to receive a payment transaction request performed by an account holder (e.g., the cardholder 104(1)) via the network 118. The processing module 1102 receives payment card information, a payment transaction amount, customer (or cardholder) information, and merchant information from the remote device 1108 (e.g., the payment server 114). The issuer server 1100 includes a transaction database 1110 for storing transaction data. The transaction data may include, but is not limited to, transaction attributes, such as transaction amount, source of funds such as bank or credit cards, transaction channel used for loading funds such as POS terminal or ATM, preauthorization transactions, transaction velocity features such as count and transaction amount sent in the past x days to a particular account holder, transaction location information, external data sources, and other internal data to evaluate each transaction. The issuer server 1100 includes a user profile database 1112 storing user profiles associated with the plurality of account holders.

The user profile data may include an account balance, a credit line, details of the account holders, account identification information, payment card number, or the like. The details of the account holders (e.g., the cardholders (104(1)-104(N)) may include, but are not limited to, name, age, gender, physical attributes, location, registered contact number, family information, alternate contact number, registered e-mail address, or the like of the cardholders 104.

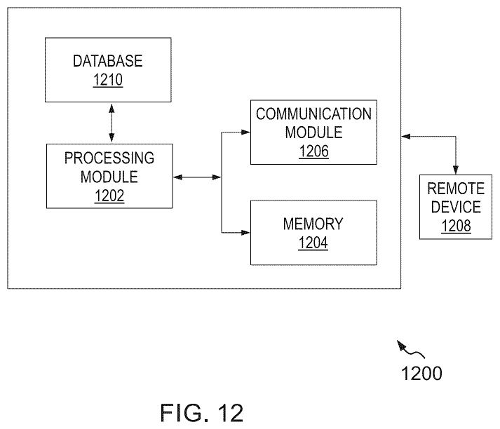

FIG. 12 illustrates a simplified block diagram of the payment server 1200, in accordance with an embodiment of the present disclosure. The payment server 1200 is an example of the payment server 114 of FIG. 1. The payment server 1200 and the server system 300 may use the payment network 112 as a payment interchange network. Examples of payment interchange networks include, but are not limited to, Mastercard® payment system interchange network.

The payment server 1200 includes a processing module 1202 configured to extract programming instructions from a memory 1204 to provide various features of the present disclosure. The components of the payment server 1200 provided herein may not be exhaustive, and the payment server 1200 may include more or fewer components than that depicted in FIG. 12. Further, two or more components may be embodied in one single component, and/or one component may be configured using multiple sub-components to achieve the desired functionalities. Some components of the payment server 1200 may be configured using hardware elements, software elements, firmware elements, and/or a combination thereof.

Via a communication module 1206, the processing module 1202 receives a request from a remote device 1208, such as the issuer servers 108, the acquirer servers 110, or the server system 102. The request may be a request for conducting the payment transaction. The communication may be achieved through API calls, without loss of generality. The payment server 1200 includes a database 1210. The database 1210 also includes transaction processing data such as issuer ID, country code, acquirer ID, and merchant identifier (MID), among others.

When the payment server 1200 receives a payment transaction request from the acquirer servers 110 or a payment terminal (e.g., IoT device), the payment server 1200 may route the payment transaction request to the issuer servers 108. The database 1210 stores transaction identifiers for identifying transaction details such as transaction amount, IoT device details, acquirer account information, transaction records, merchant account information, and the like.

In one example embodiment, the acquirer servers 110 are configured to send an authorization request message to the payment server 1200. The authorization request message includes, but is not limited to, the payment transaction request.

The processing module 1202 further sends the payment transaction request to the issuer servers 108 for facilitating the payment transactions from the remote device 1208. The processing module 1202 is further configured to notify the remote device 1208 of the transaction status in the form of an authorization response message via the communication module 1206. The authorization response message includes but is not limited to, a payment transaction response received from the issuer servers 108. Alternatively, in one embodiment, the processing module 1202 is configured to send an authorization response message for declining the payment transaction request, via the communication module 1206, to the acquirer servers 110. In one embodiment, the processing module 1202 executes similar operations performed by the server system 300, however, for the sake of brevity, these operations are not explained herein.

The disclosed method with reference to FIG. 5 and FIG. 6, or one or more operations of the server system 300 may be implemented using software including computer-executable instructions stored on one or more computer-readable media (e.g., non-transitory computer-readable media, such as one or more optical media discs, volatile memory components (e.g., DRAM or SRAM), or nonvolatile memory or storage components (e.g., hard drives or solid-state nonvolatile memory components, such as Flash memory components) and executed on a computer (e.g., any suitable computer, such as a laptop computer, netbook, Web book, tablet computing device, smartphone, or other mobile computing devices). Such software may be executed, for example, on a single local computer or in a network environment (e.g., via the Internet, a wide-area network, a local-area network, a remote web-based server, a client-server network (such as a cloud computing network), or other such networks) using one or more network computers. Additionally, any of the intermediate or final data created and used during the implementation of the disclosed methods or systems may also be stored on one or more computer-readable media (e.g., non-transitory computer-readable media) and are within the scope of the disclosed technology. Furthermore, any of the software-based embodiments may be uploaded, downloaded, or remotely accessed through a suitable communication means. Such a suitable communication means include for example, the Internet, the World Wide Web, an intranet, software applications, cable (including fiber optic cable), magnetic communications, electromagnetic communications (including RF, microwave, and infrared communications), electronic communications, or other such communication means.

Although the invention has been described with reference to specific exemplary embodiments, it is noted that various modifications and changes may be made to these embodiments without departing from the broad scope of the invention. For example, the various operations, blocks, etc., described herein may be enabled and operated using hardware circuitry (for example, complementary metal oxide semiconductor (CMOS) based logic circuitry), firmware, software, and/or any combination of hardware, firmware, and/or software (for example, embodied in a machine-readable medium). For example, the apparatuses and methods may be embodied using transistors, logic gates, and electrical circuits (for example, application-specific integrated circuit (ASIC) circuitry and/or in Digital Signal Processor (DSP) circuitry).

Particularly, the server system 300 and its various components may be enabled using software and/or using transistors, logic gates, and electrical circuits (for example, integrated circuit circuitry such as ASIC circuitry). Various embodiments of the invention may include one or more computer programs stored or otherwise embodied on a computer-readable medium, wherein the computer programs are configured to cause a processor or the computer to perform one or more operations. A computer-readable medium storing, embodying, or encoded with a computer program, or similar language, may be embodied as a tangible data storage device storing one or more software programs that are configured to cause a processor or computer to perform one or more operations. Such operations may be, for example, any of the steps or operations described herein. In some embodiments, the computer programs may be stored and provided to a computer using any type of non-transitory computer-readable media. Non-transitory computer-readable media includes any type of tangible storage media.

Examples of non-transitory computer-readable media include magnetic storage media (such as floppy disks, magnetic tapes, hard disk drives, etc.), optical magnetic storage media (e.g. magneto-optical disks), CD-ROM (compact disc read-only memory), CD-R (compact disc recordable), CD-R/W (compact disc rewritable), DVD (Digital Versatile Disc), BD (BLU-RAY® Disc), and semiconductor memories (such as mask ROM, PROM (programmable ROM), EPROM (erasable PROM), flash memory, RAM (random access memory), etc.). Additionally, a tangible data storage device may be embodied as one or more volatile memory devices, one or more non-volatile memory devices, and/or a combination of one or more volatile memory devices and non-volatile memory devices. In some embodiments, the computer programs may be provided to a computer using any type of transitory computer-readable media. Examples of transitory computer-readable media include electric signals, optical signals, and electromagnetic waves. Transitory computer-readable media can provide the program to a computer via a wired communication line (e.g., electric wires, and optical fibers) or a wireless communication line.

Various embodiments of the invention, as discussed above, may be practiced with steps and/or operations in a different order, and/or with hardware elements in configurations, which are different from those which are disclosed. Therefore, although the invention has been described based on these exemplary embodiments, it is noted that certain modifications, variations, and alternative constructions may be apparent and well within the scope of the invention.

Although various exemplary embodiments of the invention are described herein in a language specific to structural features and/or methodological acts, the subject matter defined in the appended claims is not necessarily limited to the specific features or acts described above. Rather, the specific features and acts described above are disclosed as exemplary forms of implementing the claims.

1. A computer-implemented transaction fraud detection method in a network environment comprising an issuer server and a payment server the method comprising:
receiving from issuer server or the payment server, by a server system, an embedding generation request for a real-time transaction between a cardholder and a merchant;
accessing, by the server system in response to the embedding generation request, a static embedding, a set of velocity features, and a set of real-time velocity features from a database associated with the server system, the static embedding being based, at least in part, on the set of velocity features;
computing, by the server system, a difference between the set of real-time velocity features and the set of velocity features;
generating, by a prediction model associated with the server system, a real-time embedding prediction for the real-time transaction based, at least in part, on the static embedding, the set of velocity features, and the computed difference; and
detecting, by a down-stream task model, that the real-time transaction between the cardholder and the merchant is fraudulent based at least in part on the real-time embedding prediction.

2. The computer-implemented transaction fraud detection method as claimed in claim 1, wherein accessing the set of real-time velocity features, comprises:
extracting, by the server system, one or more real-time transaction features from the embedding generation request for the real-time transaction;
generating, by the server system, the set of real-time velocity features based, at least in part, on the one or more real-time transaction features; and
storing, by the server system, the set of real-time velocity features in the database.

3. The computer-implemented transaction fraud detection method as claimed in claim 1, wherein accessing the set of velocity features and the static embedding, comprises:
accessing, by the server system, a historical transaction dataset from the database, the historical transaction dataset comprising a plurality of transaction attributes associated with each of a plurality of transactions performed between a plurality of cardholders and a plurality of merchants;
generating, by the server system, a set of cardholder features for each cardholder and a set of merchant features for each merchant based, at least, in part, on the plurality of transaction attributes;
generating, by the server system, a bipartite graph based, at least in part, on the set of cardholder features for each cardholder and the set of merchant features for each merchant, the bipartite graph comprising a set of cardholder nodes associated with the plurality of cardholders and a set of merchant nodes associated with the plurality of merchants, wherein the set of cardholder nodes and the set of merchant nodes are connected with a plurality of edges, each edge indicating a transaction performed between a particular cardholder node and a particular merchant node;
generating, by the server system, a set of cardholder velocity features for the cardholder and a set of merchant velocity features for the merchant based, at least in part, on the bipartite graph;
generating, by the server system, the set of velocity features based, at least in part, on the set of cardholder velocity features and the set of merchant velocity features; and
storing, by the server system, the set of velocity features in the database.

4. The computer-implemented transaction fraud detection method as claimed in claim 3, further comprising:
generating, by a static embedding model associated with the server system, the static embedding based, at least in part, on the set of velocity features; and
storing, by the server system, the static embedding in the database.

5. The computer-implemented transaction fraud detection method as claimed in claim 4, wherein the static embedding is updated after a predefined time duration.

6. The computer-implemented transaction fraud detection method as claimed in claim 1, further comprising:
computing, by the server system, a performance value of a static embedding model based, at least in part, on one or more performance metrics; and
re-training, by the server system, the static embedding model upon determining that the performance value is lower than a performance threshold value.

7. The computer-implemented transaction fraud detection method as claimed in claim 1, further comprising:
receiving, by the server system, a prediction request associated with a down-stream task; and
generating, by a down-stream task model associated with the server system, a task-specific prediction for the down-stream task based, at least in part, on the real-time embedding prediction.

8. The computer-implemented transaction fraud detection method as claimed in claim 1, wherein the server system is a payment server associated with a payment network.

9. A non-transitory computer-readable medium having stored therein one or more computer programs configured to cause one or more processors to perform a transaction fraud detection method in a network environment comprising an issuer server and a payment server, the method comprising:
receiving from the issuer server or the payment server, by a server system, an embedding generation request for a real-time transaction between a cardholder and a merchant;
accessing, by the server system in response to the embedding generation request, a static embedding, a set of velocity features, and a set of real-time velocity features from a database associated with the server system, the static embedding being based, at least in part. on a set of velocity features;
computing, by the server system, a difference between the set of real-time velocity features and the set of velocity features;
generating, by a prediction model associated with the server system, a real-time embedding prediction for the real-time event based, at least in part, on the static embedding, the set of velocity features, and the computed difference; and
detecting, by a down-stream task model, that the real-time transaction between the cardholder and the merchant is fraudulent based at least in part on the real-time embedding prediction.

10. The non-transitory computer-readable medium as claimed in claim 9, wherein accessing the set of real-time velocity features, comprises:
extracting, by the server system, one or more real-time event-related features from the embedding generation request for the real-time event;
generating, by the server system, the set of real-time velocity features based, at least in part, on the one or more real-time event-related features; and
storing, by the server system, the set of real-time velocity features in the database.

11. The non-transitory computer-readable medium as claimed in claim 9, wherein accessing the set of velocity features and the static embedding, comprises:
accessing, by the server system, a historical dataset from the database, the historical dataset comprising a plurality of attributes associated with a series of historical events, each historical event from the series of historical events being performed by a plurality of entities;
generating, by the server system, a set of historical event features for the series of historical events based, at least, in part, on the plurality of attributes;
generating, by the server system, an event-specific graph based, at least in part, on the set of historical event features, the event-specific graph comprising a set of entity nodes corresponding to the plurality of entities, wherein the set of entity nodes are connected with a plurality of edges, each edge indicating a relationship between distinct entity nodes from the set of entity nodes;
generating, by the server system, the set of velocity features based, at least in part, on the set of cardholder velocity features and the set of merchant velocity features; and
storing, by the server system, the set of velocity features in the database.

12. The non-transitory computer-readable medium as claimed in claim 11, further comprising:
generating, by a static embedding model associated with the server system, the static embedding based, at least in part, on the set of velocity features, wherein the static embedding is updated after a predefined time duration; and
storing, by the server system, the static embedding in the database.

13. A transaction fraud detection server system in a network environment comprising an issuer server and a payment server the transaction fraud detection server comprising:
a communication interface;
a memory comprising executable instructions; and
a processor communicably coupled to the communication interface and the memory, the processor configured to cause the server system to at least:
receive, from the issuer server or the payment server, an embedding generation request for a real-time transaction between a cardholder and a merchant;
access, in response to the embedding generation request, a static embedding, a set of velocity features, and a set of real-time velocity features from a database associated with the server system, the static embedding being based, at least in part, on the set of velocity features;
compute a difference between the set of real-time velocity features and the set of velocity features;
generate, by a prediction model associated with the server system, a real-time embedding prediction for the real-time transaction based, at least in part, on the static embedding, the set of velocity features, and the computed difference; and
supply the real-time embedding prediction to a down-stream task model and thereby cause the down-stream task model to detect, based at least in part on the real-time embedding prediction, that the real-time transaction between the cardholder and the merchant is fraudulent.

14. The transaction fraud detection server system as claimed in claim 13, wherein to access the set of real-time velocity features, the server system is further caused, at least in part, to:
extract one or more real-time transaction features from the embedding generation request for the real-time transaction;
generate the set of real-time velocity features based, at least in part, on the one or more real-time transaction features; and
store the set of real-time velocity features in the database.

15. The transaction fraud detection server system as claimed in claim 13, wherein to access the set of velocity features and the static embedding, the server system is further caused, at least in part, to:
access a historical transaction dataset from the database, the historical transaction dataset comprising a plurality of transaction attributes associated with each of a plurality of transactions performed between a plurality of cardholders and a plurality of merchants;
generate a set of cardholder features for each cardholder and a set of merchant features for each merchant based, at least, in part, on the plurality of transaction attributes;
generate a bipartite graph based, at least in part, on the set of cardholder features for each cardholder and the set of merchant features for each merchant, the bipartite graph comprising a set of cardholder nodes associated with the plurality of cardholders and a set of merchant nodes associated with the plurality of merchants, wherein the set of cardholder nodes and the set of merchant nodes are connected with a plurality of edges, each edge indicating a transaction performed between a particular cardholder node and a particular merchant node;
generate a set of cardholder velocity features for the cardholder and a set of merchant velocity features for the merchant based, at least in part, on the bipartite graph;
generate the set of velocity features based, at least in part, on the set of cardholder velocity features and the set of merchant velocity features; and
store the set of velocity features in the database.

16. The transaction fraud detection server system as claimed in claim 15, wherein the server system is further caused, at least in part, to:
generate, by a static embedding model associated with the server system, a static embedding based, at least in part, on the set of velocity features; and
store the static embedding in the database.

17. The transaction fraud detection server system as claimed in claim 16, wherein the static embedding is updated after a predefined time duration.

18. The transaction fraud detection server system as claimed in claim 13, wherein the server system is further caused, at least in part, to:
compute a performance value of a static embedding model based, at least in part, on one or more performance metrics; and
re-train the static embedding model upon determining that the performance value is lower than a performance threshold value.

19. The transaction fraud detection server system as claimed in claim 13, wherein the server system is further caused, at least in part, to:
receive a prediction request associated with a down-stream task; and
generate, by a down-stream task model associated with the server system, a task-specific prediction for the down-stream task based, at least in part, on the real-time embedding prediction.
